(19) United States
(12) Patent Application Publication
(10) Pub. No.: US 2013/0132061 A1
(43) Pub. Date: May 23, 2013

(54) JUST-IN-TIME STATIC TRANSLATION SYSTEM FOR EMULATED COMPUTING ENVIRONMENTS

(71) Applicants: Michael J. Rieschl, (US); Mitchell A. Bauman, (US); Feng-Jung Kao, (US); Edward Lusienski, (US); James R. McBreen, (US); James F. Merten, (US); Thomas L. Nowatzki, (US); David W. Schroth, (US); Scott L. Titus, (US); Judge Yohn, (US); Nathan Zimmer, (US)

(72) Inventors: Michael J. Rieschl, (US); Mitchell A. Bauman, (US); Feng-Jung Kao, (US); Edward Lusienski, (US); James R. McBreen, (US); James F. Merten, (US); Thomas L. Nowatzki, (US); David W. Schroth, (US); Scott L. Titus, (US); Judge Yohn, (US); Nathan Zimmer, (US)

(21) Appl. No.: 13/299,458

(22) Filed: Nov. 18, 2011

(51) Int. Cl. G06F 9/455

(52) U.S. Cl. 703/26

(57) ABSTRACT

A computing system and method of executing a software program and translation of instructions for an emulated computing environment. The computing system includes a programmable circuit capable of executing native instructions of a first instruction set architecture and incapable of executing non-native instructions of a second instruction set architecture. The emulator operates within an interface layer and translates non-native applications hosted within an emulated operating system for execution. The computing system includes translated memory banks defined at least in part by the emulated operating system and capable of native execution on the programmable circuit, where the emulated operating system is incapable of execution on the programmable circuit. The computing system includes a linker configured to manage association of at least one of the one or more translated memory banks to the interface layer for native execution by the programmable circuit in place of a corresponding bank of non-native instructions.

### TECHNICAL FIELD

The present disclosure relates generally to translation of computing instructions for native execution of software written for a non-native instruction set architecture. In particular, the present disclosure relates to a system for just-in-time static translation of instructions for an emulated computing environment, such as an emulated multiprocessor environment.

### BACKGROUND

Many software applications, in particular those that require a large degree of data security and recoverability, are traditionally supported by mainframe data processing systems. Such software applications may include those associated with utility, transportation, finance, government, and military installations and infrastructures. Such applications are generally supported by CMOS based mainframe systems, because mainframes provide a large degree of data redundancy, enhanced data recoverability features, and sophisticated data security features. These mainframes implement proprietary instruction sets and architectures.

As “off-the-shelf” commodity data processing systems have increased in processing power, there has been movement towards using such systems to support industries that historically employed mainframes for their data processing needs. These computer systems may be used to update legacy data, which may include records from any of the aforementioned sensitive types of applications. This scenario presents several challenges.

First, as previously alluded to, the Operating Systems (OS's) that are generally available on commodity-type systems do not include the security and protection mechanisms needed to ensure that legacy data is adequately protected. For instance, when a commodity-type OS such as Windows or Linux experiences a critical fault, the system must generally be entirely rebooted. This involves reinitializing the memory and re-loading software constructs. As a result, in many cases, the operating environment, as well as much or all of the data that was resident in memory at the time of the fault, are lost. The system is therefore incapable of re-starting execution at the point of failure. This is unacceptable in applications that require very long times between system stops.

In addition, commodity OS's such as UNIX and Linux allow operators a large degree of freedom and flexibility to control and manage the system. For instance, a user within an UNIX environment may enter a command from a shell prompt that could delete a large amount of data stored on mass storage devices without the system either intervening or providing a warning message. Such actions may be unintentionally initiated by novice users who are not familiar with the often cryptic command shell and other user interfaces associated with these operating systems. In such situations, it is important to restrict access to the underlying infrastructure to ensure security and reliability.

In some cases, these concerns are addressed by executing a mainframe emulator upon a Linux operating system that is in turn executing upon commodity instruction processors. One example arrangement of such an emulated environment is illustrated in FIG. 1. In that arrangement, a server 10 includes a firmware layer 12, an interface layer 14, and an installation layer 16. The firmware layer 12 is communicatively connected to the interface layer 14, as is the installation layer 16. The firmware layer 12 and installation layer 16 can be used for booting the server 10, as well as starting one or more system services required to interact with hardware present in the server 10. The interface layer 14 generally represents an operating system maintaining the interface between hardware resources of the server 10, and includes an emulator 18, as well as hardware interface systems such as one or more I/O drivers 20, as well as a memory management subsystem 22 and a clock 24. The hardware interface systems 20-24 generally are used by the interface layer 14 for generalized operation, and are made available to an emulated operating system 26 by the emulator 18 hosted within the interface layer 14. The emulated operating system 26 can in turn host execution or one or more applications 28a-x (in the illustration shown, 3 such applications 28a, 28b, and 28x are shown).

In operation, the server 10 cannot natively execute instructions of the emulated operating system 26 or applications 28a-x, as they are written using a different instruction set architecture that is incompatible with that provided by the server 10. Accordingly, the emulator 18 fetches one non-native (e.g., mainframe) instruction at a time from emulated main memory (via an interface to the memory management subsystem 22), and translates that instruction to one or more native instructions of the instruction set architecture supported by the server 10. The server 10 then executes the instruction using the native instruction set architecture.

Although such emulated systems represent a reasonable replacement for low end mainframe environments, they are typically relatively slower than current high-end CMOS mainframe systems. To replace these higher-end systems, such emulated systems must significantly increase the performance of the CMOS instruction processor relative to the emulated operating system to become a replacement for a high-end mainframe application.

Some efforts have been taken to improve the performance of such an emulated operating system. Generally, these efforts are focused on reducing the number of cycles required of the commodity instruction processor to perform the tasks required by the emulated mainframe system. For example, in some cases, emulation systems incorporate realtime translation engines which perform a one-for-one translation between each instruction in the emulated instruction set architecture (i.e., the mainframe architecture) and the native instruction set architecture (i.e., the instruction set architecture of the commodity device). This approach generally results in slow performance, due to the overhead required by “on the fly” translation. In other cases, a strictly static translation is performed prior to operation. This requires a large amount of memory resources, because it would require translation of the entire executable memory of the mainframe system to ensure consistent operation of the mainframe application in all possible operational scenarios. Accordingly, these existing solutions lack the required improvement in performance while retaining operational reliability required by applications that run in the emulated mainframe environment.

For these and other reasons, improvements are desirable.

### SUMMARY

In accordance with the following disclosure, the above and other issues are addressed by the following:

In a first aspect, a computing system is disclosed. The computing system includes a programmable circuit capable of executing native instructions of a first instruction set architecture and incapable of executing non-native instructions of a second instruction set architecture. The computing system includes an emulator providing translation of non-native instructions into native instructions. The emulator operates within an interface layer and translates for execution one or more non-native applications hosted within an emulated operating system. The computing system includes one or more translated memory banks defined at least in part by the emulated operating system and capable of native execution on the programmable circuit. The emulated operating system is incapable of execution on the programmable circuit. The computing system also includes a linker configured to manage association of at least one of the one or more translated memory banks to the interface layer for native execution by the programmable circuit in place of a corresponding bank of non-native instructions.

In a second aspect, a method of executing a software program on a computing system is disclosed. The computing system has a native instruction set architecture, and the software program written to be executed on a system having a non-native instruction set architecture that is not executable within the native instruction set architecture. The method includes retrieving a non-native instruction to be executed as part of the software program, the instruction included in a current memory bank. The method also includes determining whether the non-native instruction results in a transfer to a second memory bank different from the current memory bank. The method further includes, if the instruction results in transfer to a second memory bank, determining whether a translated memory bank corresponding to the second memory bank is linked to an interface layer. The method also includes, upon determining that the translated memory bank is linked to the interface layer, executing one or more instructions within the translated memory bank natively on the computing system.

In a third aspect, a computer-implemented method is disclosed. The method includes initiating execution of an emulated operating system and one or more software programs within an emulator operating within an interface layer. The emulator operates on a programmable circuit of a computing system having a first instruction set architecture, and the emulated operating system and one or more software programs are configured for execution using a second instruction set architecture incompatible with the first instruction set architecture. The method includes retrieving an instruction to be executed as part of the software program, the instruction included in a current memory bank, and determining whether the instruction results in a transfer to a memory bank different from the current memory bank. The method also includes, if the instruction results in transfer to a memory bank different from the current memory bank, determining whether a translated memory bank corresponding to the memory bank is linked to the interface layer. The method includes, upon determining that the translated memory bank corresponding to the memory bank is not linked to the interface layer, initiating a linker component to link the translated memory bank to the interface layer. The method further includes, upon determining that the translated memory bank is linked to the interface layer, executing one or more instructions within the translated memory bank natively on the computing system.

### BRIEF DESCRIPTION OF THE DRAWINGS

FIG. 1 illustrates a prior art computing system in which one or more non-native software programs can be emulated;

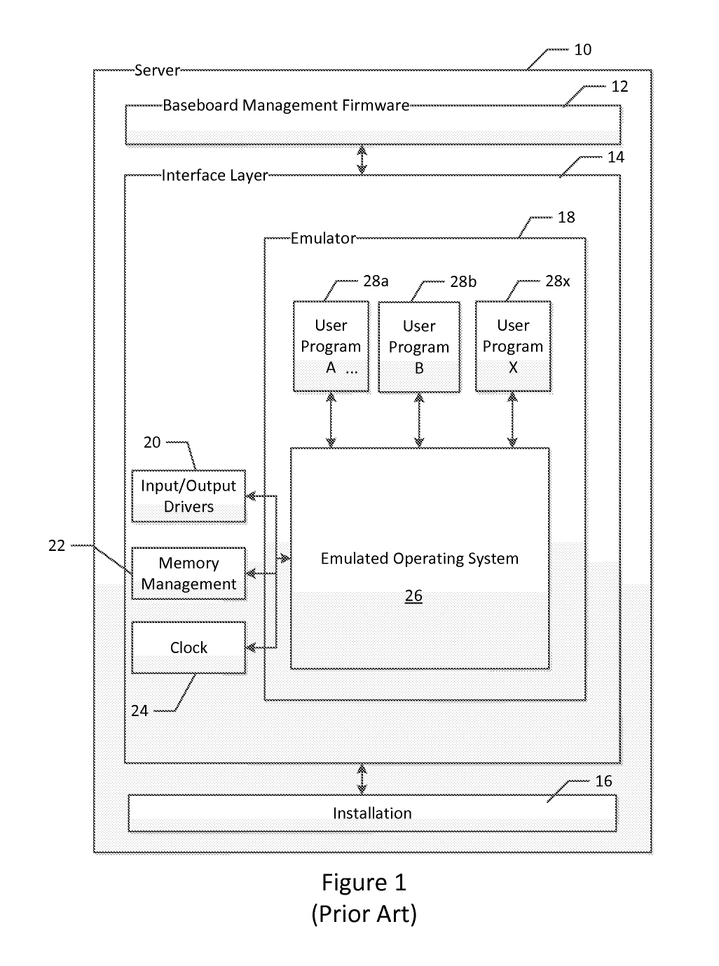

FIG. 2 illustrates a just-in-time static translation emulation system operable within a computing system, according to a possible embodiment of the present disclosure;

FIG. 3 illustrates a portion of an example computing system in which the just-in-time static translation emulation system can be implemented;

FIG. 4 illustrates an electronic computing device with which aspects of the just-in-time static translation emulation system can be implemented;

FIG. 5 is a flowchart illustrating operation of an emulated operating system to manage linking of a static translated memory bank in conjunction with a linker component, according to a possible embodiment of the present disclosure;

FIG. 6 is a flowchart illustrating operation of an emulated operating system to unlink a static translated memory bank in conjunction with a linker component, according to a possible embodiment of the present disclosure;

FIG. 7 is a flowchart illustrating operation of a linker component, according to a possible embodiment of the present disclosure;

FIG. 8 is a flowchart of an unlinker component used to disassociate a static translated memory bank from an emulator, according to a possible embodiment of the present disclosure; and

FIG. 9 is a flowchart illustrating operation of a bank transfer module useable in a just-in-time static translation emulation system, according to a possible embodiment of the present disclosure.

### DETAILED DESCRIPTION

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

The logical operations of the various embodiments of the disclosure described herein are implemented as: (1) a sequence of computer implemented steps, operations, or procedures running on a programmable circuit within a computer, and/or (2) a sequence of computer implemented steps, operations, or procedures running on a programmable circuit within a directory system, database, or compiler.

In general the present disclosure relates to methods and systems for executing non-native binary code representing one or more software programs on a computing system. By non-native, it is intended that a binary code stream that represents a software program and is received by a computing system cannot be executed directly on that computing system without some type of translation, for example within an emulator or other pre-execution translation system.

The systems and methods of the present disclosure provide increased efficiency and reliability in executing emulated code streams by pre-translating memory banks, and then natively executing those translated memory banks, rather than dynamically translating then executing the non-native binary code on an instruction-by-instruction basis. This allows for both improved performance due to offloading the overheard required by dynamic translation, and allows for recoverability, because the unit of translation is a mainframe bank and if a problem occurs the bank may be reverted back to the emulated (non-native) bank, for translation on an instruction-by-instruction basis only if necessary.

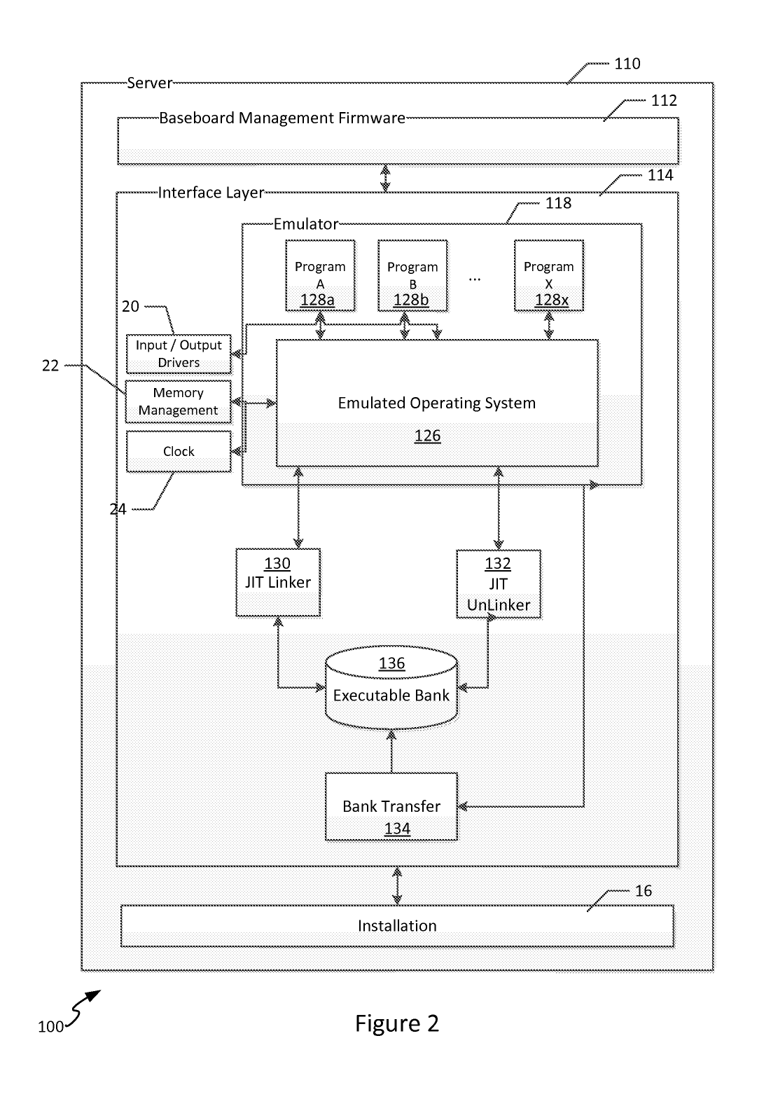

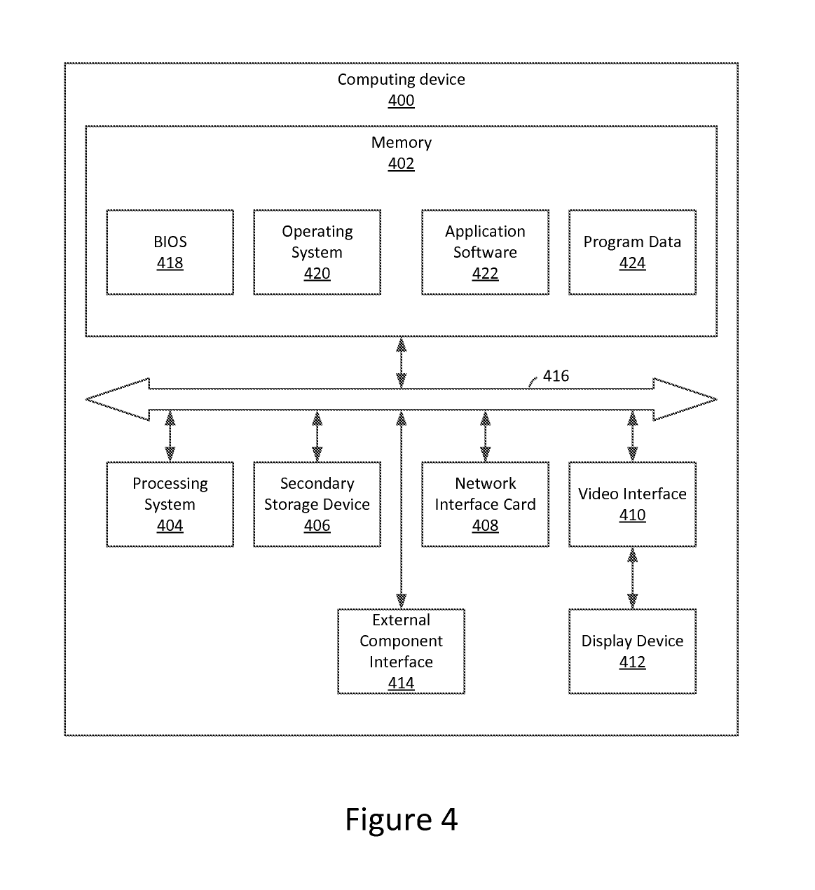

Referring now to FIG. 2, a just-in-time (“JIT”) static translation emulation system 100 is shown, operable within a computing system. In the embodiment shown, the emulation system 100 executes on a server 110. An example server is described in further detail below in conjunction with FIG. 4; however, in general the server corresponds to a multi-processor computing system having a commodity instruction set architecture. In some embodiments of the present disclosure, the server 110 operates using an Intel-based instruction set architecture (e.g., IA32, IA32-x64, IA64, etc.); however, other instruction set architectures could be used.

In the embodiment shown, the server 110 includes a firmware layer 112, an interface layer 114, and an installation layer 116. The firmware layer 112 and the installation layer 116 are each communicatively connected to the interface layer 114. As with other emulation systems, the firmware layer 112 and installation layer 116 can be used for booting the server 110, as well as starting one or more system services required to interact with hardware present in the server 110. The interface layer 114 generally represents an operating system maintaining the interface between hardware resources of the server 110. The interface layer 114 can be, in certain embodiments, an operating system compiled for execution on a native instruction set architecture, such as a Linux- or Unix-based operating system. In alternative embodiments, other operating systems could be used, such as a Windows operating system provided by Microsoft Corporation of Redmond, Wash.

In the embodiment shown, the interface layer 114 includes an emulator 118, as well as hardware interface systems such as one or more I/O drivers 120, as well as a memory management subsystem 122 and a clock 124. The hardware interface systems 120-124 generally are used by the interface layer 114 for generalized operation, and are made available to an emulated operating system 126 by the emulator 118 hosted within the interface layer 114. Any of a variety of emulated operating systems can be used, such that the emulated operating system is implemented using a non-native instruction set architecture. In one possible embodiment, the emulated operating system is the OS2200 operating system provided by Unisys Corporation of Blue Bell, Pa. Other emulated operating systems could be used as well, but generally refer to operating systems of mainframe systems.

The emulated operating system 126 can host execution or one or more applications 128a-x (in the illustration shown, 3 such applications 28a, 28b, and 28x are shown). The applications 128a-x are generally maintained in a memory managed by the emulated operating system 126 by separating that memory into memory banks. In the context of the present disclosure, these memory banks are also referred to as non-native memory banks, or banks of non-native instructions. This means that the applications 128a-x defined by the instructions maintained in those banks are written for execution on a non-native instruction set architecture not directly executable by the server 110. Although the size of such memory banks may vary based on the emulated operating system used, in a possible embodiment each memory bank has a size of 262 k words. Other memory bank sizes may be used as well.

In contrast to prior art systems, the interface layer 114 as illustrated in this embodiment also includes a linker component 130, an unlinker component 132, and a bank transfer module 134, each of which are interfaced to one or more translated memory banks in a data store 136. The translated memory banks correspond to emulated, non-native memory banks managed by the emulated operating system 126, but are translated into native instructions, which can be directly executed on the server 110 without requiring further instruction-by-instruction translation.

The linker component 130 manages association of one or more of the translated memory banks in the data store 136 to the emulator 118, which selectively directs execution either (1) from a translated memory bank, natively on the server 110, or (2) based on instruction-by-instruction translation from a non-native memory bank defined by the emulated operating system 126, if no translated memory bank exists or is capable of being linked to the emulator 118.

The unlinker 132 disassociates translated memory banks from the emulator 118. For example, in certain embodiments, only a predetermined number of memory banks can be associated at once with the emulator, for example due to physical memory constraints of the server 110. In such circumstances, only a subset of the available translated memory banks in the data store 136 may be linked to the emulator 118 at once. When a maximum number of translated memory banks has been reached but operation of an application has transferred to an unlinked (but translated) memory bank, one of the currently linked memory banks is disassociated from the emulator 118 by the unlinker 132 (e.g., based on being a least recently used translated memory bank, or other analogous scheme). This will allow the linker 130 to associate the relevant unlinked translated memory bank with the emulator 118 for native execution on the server 110.

The bank transfer module 134 transfers memory banks of non-native instructions to the data store 136, where they can be accessed and translated by a translator component. Additional details regarding translation are provided below.

In use, when the emulator 118 fetches an instruction that transfers control from one bank to another a check is made to see if a translated version of that memory bank has been linked to the emulator 118 within the interface layer 114. If the bank has been linked, the emulator 118 will call the bank directly within the interface layer. The bank executes directly on the instruction processor associated with the server 110, and continues to execute within that environment until another bank transfer or an error exception occurs.

In certain embodiments, overall management of memory banks is provided by the emulated operating system 126, such that the emulated operating system defines one or more memory banks of non-native instructions forming an application to be executed; as needed, the emulated operating system can then trigger translation of the non-native instructions in a particular memory bank to native instructions. The emulated operating system 126 can, when the translated memory bank is formed, trigger operation of the linker 130 to link the translated memory bank to the emulator 118, which can direct execution to occur from the native instructions included in that linked, translated memory bank. As such, the loading, linking, and unlinking of memory banks is controlled by the emulated operating system 126. This provides the necessary reliability in that the emulated operating system controls memory bank management, as opposed to allowing translation at a lower level (e.g., by the emulator 118 or interface layer 114.

It is noted that, if a problem occurs during translation of a memory bank or native execution from that memory bank, operation can revert to execution from an emulated memory bank of non-native instructions, using traditional instruction-by-instruction translation. The translated memory bank can then be examined for errors. Furthermore, the emulated operating system 126 can generate hash values associated with each of the translated memory banks, such that a mismatched hash value may indicate an error or tampering with that translated memory bank, and would trigger retranslation of the non-native version of that memory bank.

Additionally, by translating the memory banks to native instructions, those native instructions can be scheduled and executed using the interface layer 114 and instruction set architecture of the server 110. Accordingly, the particular instruction set architecture and organization of the processing units in the server 110 can be utilized, including registers, memory, out-of-order execution techniques, and other efficiencies that would otherwise be unavailable if instruction-by-instruction translation in an emulator were the only mechanism available.

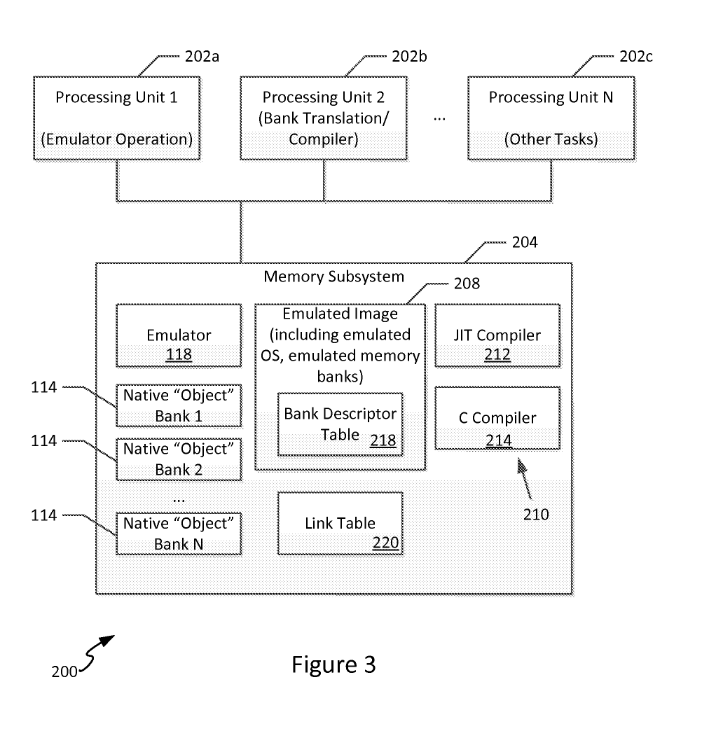

Referring now to FIG. 3, a portion of an example computing system 200 is shown in which the just-in-time static translation emulation system can be implemented. The example computing system 200 represents a portion of a system, such as server 110 of FIG. 2, which can manage execution of the just-in-time (“JIT”) static translation emulation system 100. In the embodiment shown, the example computing system 200 includes a plurality of programmable circuits, shown as processing units 202a-x (referred to collectively as processing units 202).

In the embodiment shown, each of the processing units 202 is communicatively connected to a memory subsystem 204. The memory subsystem includes an emulator 118, which is configured to translate and execute an emulated image 208. The emulated image 208 can include, for example, a non-native operating system and associated non-native applications managed by the non-native operating system. For example, the emulated image 208 can represent a mainframe operating system, such as the OS2200 operating system from Unisys Corporation of Blue Bell, Pa., as well as one or more applications designed for operation using that operating system and its associated instruction set architecture.

The memory subsystem further includes the emulator 118 described above, as well as a translator component 210 that includes a just-in-time (“JIT”) compiler 212 and a C compiler 214. The translator component 210 is configured to receive an indication from the emulated operating system (during execution of the emulated image 208 within emulator 118) of the existence of a non-native memory bank. The translator component 210 converts the non-native memory bank to a native, or “translated” memory bank. In an example implementation, a JIT compiler 212 in the translator component 210 parses the instructions and data in the non-native memory bank, and translates those non-native instructions to source code. As a second step, a C compiler 214 (or other equivalent compiler), compiles the source code into native instructions, resulting in a translated, native memory bank, translated on an instruction-by-instruction manner. In the embodiment shown, a plurality of translated memory banks 216a-n are shown (illustrated as native “object” banks generated from emulated memory banks within the emulated image 208), following translation by the translator component 210. In example embodiments, the translated memory banks 216a-n are stored in files managed within an interface layer or other native operating environment, while non-native memory banks are managed within the emulated image 208. Other embodiments providing for management of memory structures are possible as well.

In addition to the above-discussed memory structures, the memory subsystem 204 further includes a bank descriptor table (“BDT”) 218 and a link table 220. The bank descriptor table 218 is generated and managed within the emulated operating system, and stores information about available banks for management by the emulated operating system. The link table 220 tracks which of the translated memory banks are linked to an interface layer operating within the interface layer; in other words, the link table manages translated, native memory banks while the bank descriptor table 218 manages the emulated, non-native memory banks included within the emulated image 208. In example embodiments, the bank descriptor table 218 can contain indexed entries to each of the banks managed by an emulated operating system, including information regarding the usage of the bank, its address, and additionally a link bit defining whether the bank has an equivalent translated version that is directly executable on the interface layer. Analogous fields can be included in the link table, such as a link bit, an index, and a timestamp (for tracking the oldest linked memory bank for bank management purposes).

During typical operation, execution of an emulator 118 and associated non-native applications hosted within that emulator are assigned to a particular programmable circuit 202. In the embodiment shown, execution of the emulated image 208 within an emulator is assigned to processing units 202a, while translation performed by the translator component 210 can be offloaded to a different processing unit 202b. In this way, the first processing unit 202a is dedicated to executing the emulated image 208, such that a minimum amount of overhead (i.e., time not dedicated to direct execution of the emulated, mainframe system defined by the emulated image 208) is required.

Referring now to FIG. 4, a block diagram illustrating an example computing device 400 is shown, which can be used to implement aspects of the present disclosure. In particular, the computing device 400 can represent a server, such as server 110 of FIG. 2, or a multiprocessor computing system, such as system 200 of FIG. 3.

In the example of FIG. 4, the computing device 400 includes a memory 402, a processing system 404, a secondary storage device 406, a network interface card 408, a video interface 410, a display unit 412, an external component interface 414, and a communication medium 416. The memory 402 includes one or more computer storage media capable of storing data and/or instructions. In different embodiments, the memory 402 is implemented in different ways. For example, the memory 402 can be implemented using various types of computer storage media.

The processing system 404 includes one or more processing units. A processing unit is a physical device or article of manufacture comprising one or more integrated circuits that selectively execute software instructions. In various embodiments, the processing system 404 is implemented in various ways. For example, the processing system 404 can be implemented as one or more processing cores. In another example, the processing system 404 can include one or more separate microprocessors. In yet another example embodiment, the processing system 404 can include an application-specific integrated circuit (ASIC) that provides specific functionality. In yet another example, the processing system 404 provides specific functionality by using an ASIC and by executing computer-executable instructions.

The secondary storage device 406 includes one or more computer storage media. The secondary storage device 406 stores data and software instructions not directly accessible by the processing system 404. In other words, the processing system 404 performs an I/O operation to retrieve data and/or software instructions from the secondary storage device 406. In various embodiments, the secondary storage device 406 includes various types of computer storage media. For example, the secondary storage device 406 can include one or more magnetic disks, magnetic tape drives, optical discs, solid state memory devices, and/or other types of computer storage media.

The network interface card 408 enables the computing device 400 to send data to and receive data from a communication network. In different embodiments, the network interface card 408 is implemented in different ways. For example, the network interface card 408 can be implemented as an Ethernet interface, a token-ring network interface, a fiber optic network interface, a wireless network interface (e.g., Wi-Fi, WiMax, etc.), or another type of network interface.

The video interface 410 enables the computing device 400 to output video information to the display unit 412. The display unit 412 can be various types of devices for displaying video information, such as a cathode-ray tube display, an LCD display panel, a plasma screen display panel, a touch-sensitive display panel, an LED screen, or a projector. The video interface 410 can communicate with the display unit 412 in various ways, such as via a Universal Serial Bus (USB) connector, a VGA connector, a digital visual interface (DVI) connector, an S-Video connector, a High-Definition Multimedia Interface (HDMI) interface, or a DisplayPort connector.

The external component interface 414 enables the computing device 400 to communicate with external devices. For example, the external component interface 414 can be a USB interface, a FireWire interface, a serial port interface, a parallel port interface, a PS/2 interface, and/or another type of interface that enables the computing device 400 to communicate with external devices. In various embodiments, the external component interface 414 enables the computing device 400 to communicate with various external components, such as external storage devices, input devices, speakers, modems, media player docks, other computing devices, scanners, digital cameras, and fingerprint readers.

The communications medium 416 facilitates communication among the hardware components of the computing device 400. In the example of FIG. 4, the communications medium 416 facilitates communication among the memory 402, the processing system 404, the secondary storage device 406, the network interface card 408, the video interface 410, and the external component interface 414. The communications medium 416 can be implemented in various ways. For example, the communications medium 416 can include a PCI bus, a PCI Express bus, an accelerated graphics port (AGP) bus, a serial Advanced Technology Attachment (ATA) interconnect, a parallel ATA interconnect, a Fiber Channel interconnect, a USB bus, a Small Computing system Interface (SCSI) interface, or another type of communications medium.

The memory 402 stores various types of data and/or software instructions. For instance, in the example of FIG. 4, the memory 402 stores a Basic Input/Output System (BIOS) 418 and an operating system 420. The BIOS 418 includes a set of computer-executable instructions that, when executed by the processing system 404, cause the computing device 400 to boot up. The operating system 420 includes a set of computer-executable instructions that, when executed by the processing system 404, cause the computing device 400 to provide an operating system that coordinates the activities and sharing of resources of the computing device 400. Furthermore, the memory 402 stores application software 422. The application software 422 includes computer-executable instructions, that when executed by the processing system 404, cause the computing device 400 to provide one or more applications. The memory 402 also stores program data 424. The program data 424 is data used by programs that execute on the computing device 400.

Although particular features are discussed herein as included within an electronic computing device 400, it is recognized that in certain embodiments not all such components or features may be included within a computing device executing according to the methods and systems of the present disclosure. Furthermore, different types of hardware and/or software systems could be incorporated into such an electronic computing device.

In accordance with the present disclosure, the term computer readable media as used herein may include computer storage media and communication media. As used in this document, a computer storage medium is a device or article of manufacture that stores data and/or computer-executable instructions. Computer storage media may include volatile and nonvolatile, removable and non-removable devices or articles of manufacture implemented in any method or technology for storage of information, such as computer readable instructions, data structures, program modules, or other data. By way of example, and not limitation, computer storage media may include dynamic random access memory (DRAM), double data rate synchronous dynamic random access memory (DDR SDRAM), reduced latency DRAM, DDR2 SDRAM, DDR3 SDRAM, DDR4 SDRAM, solid state memory, read-only memory (ROM), electrically-erasable programmable ROM, optical discs (e.g., CD-ROMs, DVDs, etc.), magnetic disks (e.g., hard disks, floppy disks, etc.), magnetic tapes, and other types of devices and/or articles of manufacture that store data. Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

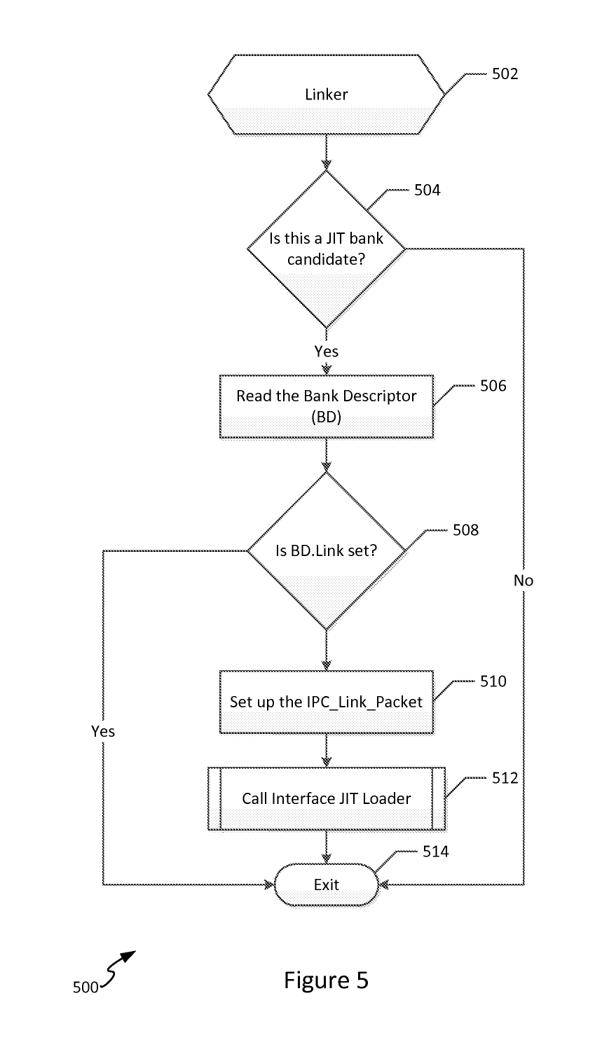

Referring now to FIGS. 5-9, flowcharts illustrating operation of various components of a server computing system are illustrated. FIG. 5 is a flowchart illustrating a method 500 of operation of an emulated operating system to manage linking of a static translated memory bank in conjunction with a linker component, according to a possible embodiment of the present disclosure. The method 500 can be, in certain embodiments, executed within an emulated operating system, such as emulated OS 126 of FIG. 2, and can operate within the computing systems discussed above with respect to FIGS. 2-4.

The method 500 is initially called by a linker module 502 in the emulated operating system, for example in the case where a new memory bank is to be addressed. Operational flow proceeds to a bank candidate assessment operation 504, in which a bank information table managed by the emulated operating system is searched to determine if a translated memory bank exists which can be natively executed by the interface layer, and which corresponds to the new memory bank implicated in the emulated operating system.

If the bank implicated by a new instruction (e.g., to transfer between banks) is present in the bank descriptor table, operational flow proceeds to a bank descriptor access operation 506, which reads a bank descriptor entry in the bank descriptor table. The bank descriptor entry can be, in certain embodiments, represent a basic storage structure used for managing the addressing environment of the emulated operating system, and can include, among other elements, information about the type of bank referenced, upper and lower limit addresses of the bank, a virtual base address for the bank, and a bank descriptor index. The bank descriptor entry can also include a link bit indicating whether the bank has been linked to the interface layer (e.g., via a previously-executed static translation and association of the bank with the interface layer for native execution.

If the link bit is set, this indicates that the bank is already linked to the interface layer, and as such the method can terminate at exit operation 508. However, if the link bit within a bank descriptor entry is not set, operational flow proceeds to a process control link packet setup operation 510, which sets the link bit in the bank descriptor entry. A linker call operation 512 calls the linker component via an inter-processor control instruction, and the linker initiates operation. Once the linker call operation 512 completes, operational flow proceeds to the exit operation 508.

Additionally, and referring back to the bank candidate assessment operation 504, if the bank is not in the table, operational flow also proceeds to the exit operation 508.

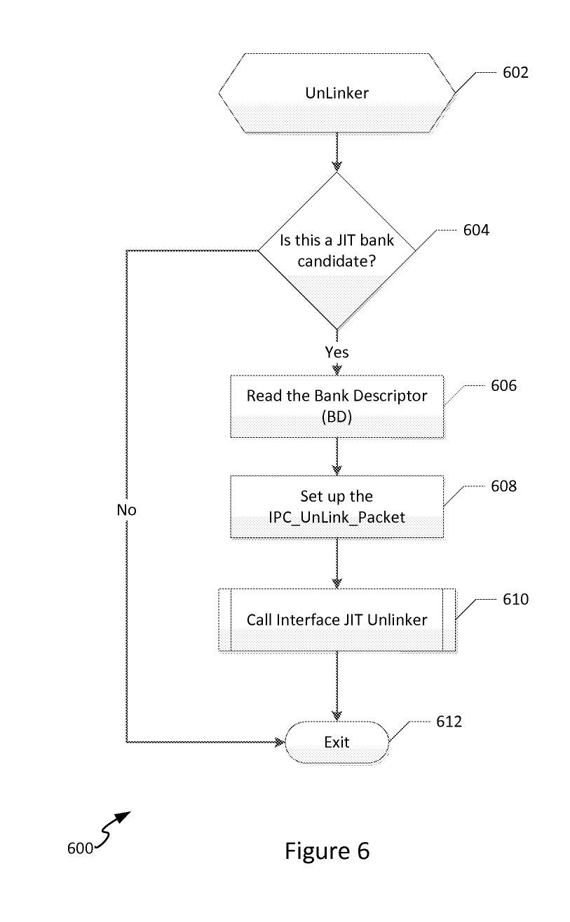

Also within the emulated operating system, FIG. 6 illustrates a method 600 used to trigger unlinking of a static translated memory bank in conjunction with a linker component. In the embodiment shown, the method 600 is triggered by an unlinker operation 602, for example as might be called by a linker component to make way for a different translated memory bank to be linked for native execution on a processing unit. Once triggered, in the embodiment shown a bank candidate assessment operation 604 searches the bank descriptor table to see if the block identified by the instruction was one of the candidate banks for native execution on a server. If so, operational flow proceeds to a bank descriptor access operation 606, which reads a bank descriptor entry. An unlink bank operation 608 sets up an inter-processor control instruction designed to unlink the referenced translated memory bank. An unlinker call operation 610 calls an unlinker component (e.g., component 132 of FIG. 2), which in turn unlinks the memory bank from the interface layer, thereby discarding the unneeded translated memory bank. An exit operation 612 completes execution of the method 600 within the emulated operating system.

Also, referring back to the bank candidate assessment operation 604, if the block identified by the instruction was not included in the candidate banks for native execution, operational flow proceeds to an exit operation 612.

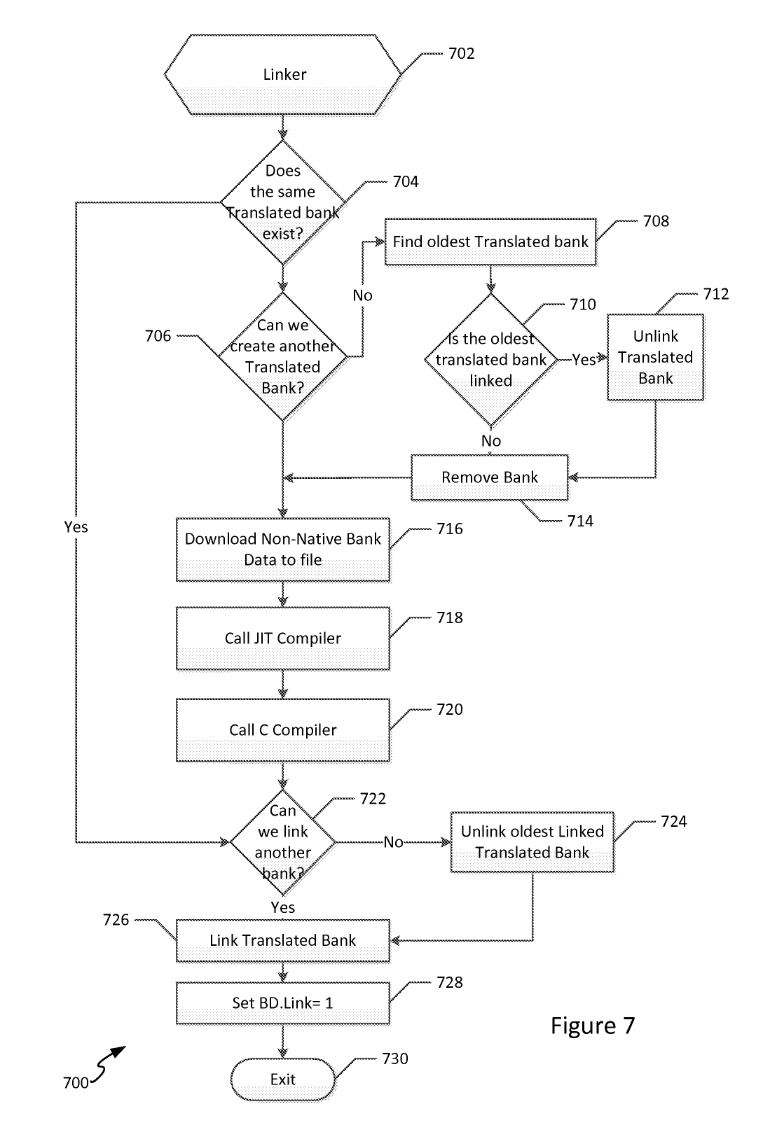

FIG. 7 is a flowchart illustrating a method 700 of operation of a linker component, according to a possible embodiment of the present disclosure. The method can be implemented, for example, in linker component 130 of FIG. 2, above. The method is instantiated by a linker operation 702, which corresponds to the linker component being called by an emulated operating system, for example as discussed above with respect to FIGS. 5-6. The linker operation 702 passes to the linker component an identifier of a particular memory bank to be linked, for example as an index to a particular bank entry of a bank descriptor table, within an inter-processor control instruction. As discussed herein, the inter-processor control instruction includes a set of bits defining the bank to be used, linked, or translated (depending on context), including both an identifier and an index to a bank descriptor in the bank descriptor table. By including both items, the bank can be tracked both by the interface layer, which can use an identifier, and by the emulated operating system, which uses the bank descriptor table.

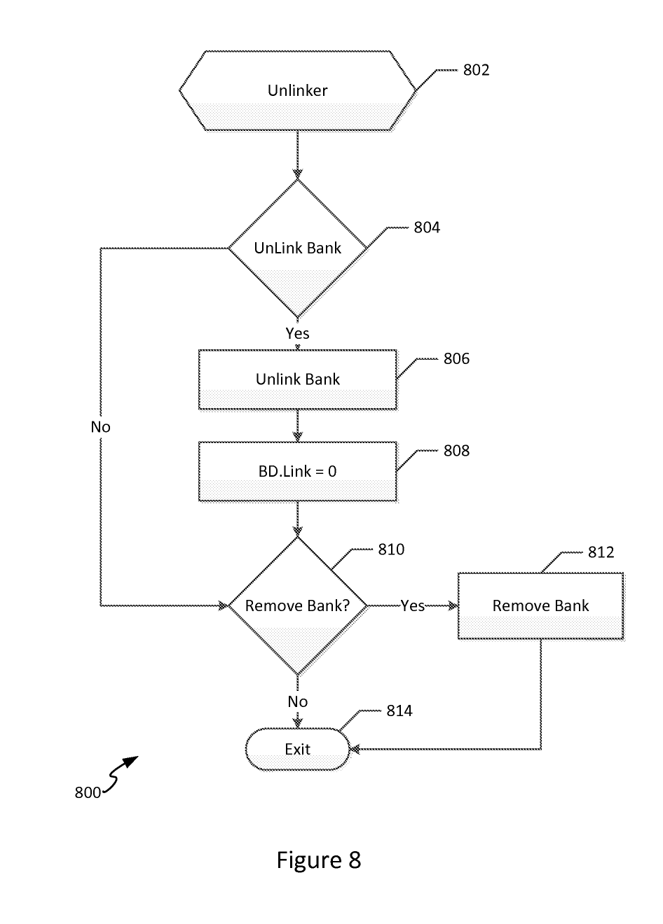

A comparison operation 704 compares the bank identifier to current set of translated memory banks, to determine if the bank already exists as a translated memory bank. If the bank defined by the bank identifier does not already exist, an assessment operation 706 determines whether an additional translated memory bank, or “object” bank, can be created. If no more translated memory banks can be created and linked to the transport layer, this may be because a maximum number of translated memory banks has been reached. In this case, an oldest bank locator operation 708 determines the oldest translated memory bank currently in existence. A link determination operation 710 determines whether the located oldest translated memory bank is currently linked to the interface layer. If that identified translated memory bank is linked, an unlink operation 712 calls an unlinker component to remove an association between that oldest translated memory bank and the interface layer. Example operation of the unlinker component is described in further detail in FIG. 8, below. Following the unlink operation (or directly from the link determination operation 710 if no link exists), a removal operation 714 removes the file containing the translated memory bank from the interface layer.

Following removal of the oldest translated memory bank, or if an additional memory bank can be created (as determined by the assessment operation 706), operational flow also continues to the download operation 716. The download operation downloads non-native memory bank data to a file for analysis and translation by a translation component. The translation component is then called, to translate the data from the non-native memory bank into a translated, native memory bank. Specifically, a JIT compiler operation 718 calls a JIT compiler, for execution on a separate processing unit from the emulated operating system and linker. Once the JIT compiler translates the non-native instructions into source code, a C compiler operation 720 calls a second compiler to execute on that separate processing unit, translating the source code into native instructions. By recompiling the source code specifically for the instruction set architecture on which the interface layer is run, architectural features of that computing system can be exploited by that second compiler.

Once the translated memory bank is created by the second compiler, a bank linking determination operation 722 determines whether the translated memory bank can be linked to the interface layer. If the interface layer will not accept additional linked memory banks, an unlinking operation 724 calls the unlinker component (operation of which is described below in FIG. 8) to remove the association between an oldest translated memory bank and the interface layer. Following the unlinking operation 724, or if the bank linking determination operation 722 determines that additional banks can be linked to the interface layer, a link operation 726 associates the translated memory bank with the instruction layer, for native execution on a processing unit of a server. In certain embodiments, this includes updating a link bit in a link table, such as table 220 of FIG. 3. A record update operation 728 then updates a corresponding link bit associated with a bank descriptor entry in the bank descriptor table, to reflect the fact that the new memory bank is linked to the interface layer. Upon completion of the record update operation, an exit operation 730 corresponds to completed execution of the linker component, in this embodiment.

It is noted that in alternative embodiments of a linker component, different operations may be implemented, and different orders of operations may be performed. For example, it may be possible to include more or fewer steps for translating non-native memory banks into translated memory banks, and this may occur before or after older memory banks are unlinked from the interface layer. Other variations in implementation of the linker component could be provided as well.

Referring now to FIG. 8, a flowchart illustrating a method 800 of operation of an unlinker component is illustrated. The method 800 can be performed, in some embodiments, by an unlinker component 132 as described above in connection with FIG. 2. The method 800 is called in an unlinker operation 802 by the emulated operating system, for example by an unlink bank operation 608 mentioned above with respect to FIG. 6, which may in some circumstances be triggered by the linker component, as described in connection with FIG. 7. In such embodiments, the unlinker component is passed an inter-processor control instruction from the emulated operating system including an identity of a particular translated memory bank to be unlinked, for example an index into a bank descriptor table pointing to a particular bank.

An unlink determination operation 804 determines whether the bank identified in the inter-processor control instruction requires unlinking If so, an unlink operation 806 unlinks the bank from the interface layer. In some embodiments, the unlink operation 804 includes updating a corresponding entry in a link table. A bank descriptor update operation 808 updates the bank descriptor entry associated with that translated memory bank to change the corresponding link bit in that entry, identifying the bank as being unlinked.

Following the unlink operation 806 and bank descriptor update operation 808, or in the case unlinking is not necessary (as determined by the unlink determination operation 804), a removal determination operation 810 determines whether the bank is to be removed, as defined in the inter-processor control instruction. If the bank is to be removed, a removal operation 812 removes the translated memory bank from memory. An exit operation 814, occurring after removal (if necessary) or determination that removal is not needed (as determined by the removal determination operation 810) corresponds to completed unlinking of the translated memory bank.

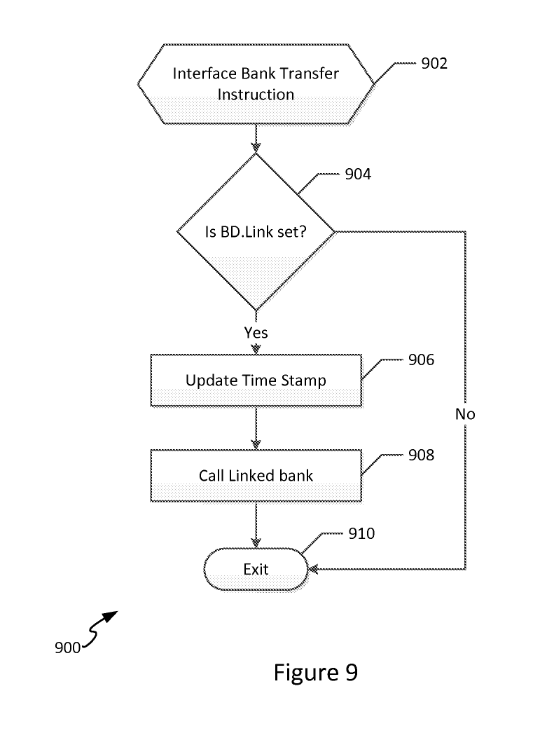

Referring now to FIG. 9, a flowchart illustrating a method 900 of operating a bank transfer module is illustrated. The method 900 can be implemented, in some embodiments, in a bank transfer module 134 of FIG. 2; however, other implementations in which different operations are performed or in which the bank transfer is integrated into another functional module may be possible as well.

In the embodiment shown, the method 900 is initiated by an inter-processor control instruction from the emulated operating system executing within the emulator, such as might occur upon receipt of an instruction at the emulator indicating that a change from a current memory bank to a new memory bank is about to occur. In such a circumstance, a bank transfer operation 902 calls the method 900, and initiates operation of the bank transfer module 134.

Once initiated, a link assessment operation 904 determines whether the new memory bank implicated by the inter-processor control instruction is already linked to the interface layer for execution. If it is linked, a timestamp update operation 906 updates a timestamp tracked in the link table, used for tracking which linked memory bank is the least recently used for unlinking purposes. A call operation 908 calls the linked bank for execution. An exit operation 910 corresponds to completed selection of the linked translated memory bank and initiated execution of the translated instructions in that memory bank.

If the link assessment operation 904 determines that the memory bank is not linked, the method is exited at the exit operation 910, upon which time the memory bank will either be linked (if possible) using the linker component as discussed above, or will be executed from the emulator on an instruction-by-instruction basis.

Referring now to FIGS. 5-9 generally, it is recognized that other arrangements of operations may be possible, and more or fewer operations may be used, according to a particular implementation. For example, and as mentioned above with respect to FIG. 7, various orders of operations of the linker component could be provided. The same may be true of the methods implemented with respect to both the unlinker component, translation component, or bank transfer module disclosed herein. Accordingly, the illustrated order of operations provides only examples of possible implementations of the linking and unlinking components described herein, and are not intended to represent the only possible arrangement by which the Just-in-Time translation of an emulated system could be accomplished within the scope of the present disclosure.

Referring back to FIGS. 2-9 generally, it can be seen that, in the context of the present disclosure, the Just-in-Time translation and management of linked memory banks allows a native operating system, such as the interface layer disclosed herein, to execute native instructions that are translated directly from an emulated system, such as a mainframe operating system and associated applications. This just-in-time translation allows the native operating system to exploit architectural features of the native operating system through use of compiler optimizations for that particular architecture. Additionally, it allows for reduced overhead, by essentially creating and caching native versions of portions of the emulated system, rather than translating the entire emulated system. This results in maintaining the improved reliability of a realtime-translated system (i.e., lower chance of data errors or translation errors corrupting an entire translation of an emulated system), while gaining substantial performance efficiency of having key portions of the emulated system be translated to native instructions. Other advantages are apparent from the present disclosure as well.

The above specification, examples and data provide a complete description of the manufacture and use of the composition of the invention. Since many embodiments of the invention can be made without departing from the spirit and scope of the invention, the invention resides in the claims hereinafter appended.

1. A computing system comprising:
a programmable circuit capable of executing native instructions of a first instruction set architecture and incapable of executing non-native instructions of a second instruction set architecture;
an emulator providing translation of non-native instructions into native instructions, the emulator translating for execution one or more non-native applications hosted within an emulated operating system;
one or more translated memory banks defined at least in part by the emulated operating system, the one or more translated memory banks capable of native execution on the programmable circuit, and the emulated operating system incapable of execution on the programmable circuit; and
a linker configured to manage association of at least one of the one or more translated memory banks to an interface layer for native execution by the programmable circuit in place of a corresponding bank of non-native instructions.

2. The computing system of claim 1, further comprising a bank transfer module communicatively connected to the emulator and configured to, upon determining that a current instruction being executed by the interface layer is included within a linked translated memory bank, initiating native execution of the linked translated memory bank on the programmable circuit.

3. The computing system of claim 1, further comprising an unlinker configured to remote an association between the interface layer and one or more of the translated memory banks.

4. The computing system of claim 1, wherein the linker is configured to call the unlinker upon determination that a maximum number of translated memory banks capable of association with the interface layer has been reached.

5. The computing system of claim 1, wherein each of the one or more translated memory banks has a corresponding non-native memory bank managed by the emulated operating system.

6. The computing system of claim 1, wherein the emulator executes on the programmable circuit.

7. The computing system of claim 1, further comprising:
a second programmable circuit;
a compiler executing on the second programmable circuit, the compiler configured to create the one or more translated memory banks.

8. The computing system of claim 7, wherein the compiler includes:
a translator component configured to generate source code based on non-native instructions included in a memory bank received from the emulated operating system, and
a compiler component configured to compile the translated code into a translated memory bank.

9. The computing system of claim 1, wherein the interface layer includes at least a portion of a native operating system.

10. A method of executing a software program on a computing system having a native instruction set architecture, the software program written to be executed on a system having a non-native instruction set architecture that is not executable within the native instruction set architecture, the method comprising:
retrieving a non-native instruction to be executed as part of the software program, the instruction included in a current memory bank;
determining whether the non-native instruction results in a transfer to a second memory bank different from the current memory bank;
if the instruction results in transfer to a second memory bank, determining whether a translated memory bank corresponding to the second memory bank is linked to an interface layer;
upon determining that the translated memory bank is linked to the interface layer, executing one or more instructions within the translated memory bank natively on the computing system.

11. The method of claim 10, wherein retrieving the instruction to be executed as part of the software program occurs within the emulator.

12. The method of claim 10, further comprising, upon completing execution of the instructions in the translated native memory bank natively on the computing system, transferring operation to a subsequent memory bank.

13. The method of claim 12, wherein completing execution of the instructions in the translated memory bank includes reaching a bank transfer instruction within the translated memory bank.

14. The method of claim 12, wherein completing execution of the instructions in the translated memory bank includes reaching an error exception.

15. The method of claim 12, wherein the subsequent memory bank is a second translated memory bank capable of native execution on the computing system.

16. The method of claim 12, wherein the subsequent memory bank is an emulated memory bank.

17. The method of claim 10, wherein the current memory bank and the second memory bank are defined in an emulated operating system executing within the emulator.

18. The method of claim 10, further comprising linking one or more translated memory banks to the interface layer, the one or more translated memory banks including the translated memory bank.

19. The method of claim 18, further comprising, prior to executing the software program, translating one or more emulated memory banks to create at least a portion of the one or more translated memory banks.

20. The method of claim 10, further comprising, upon determining that the translated memory bank is not linked to the interface layer, linking the translated memory bank to the interface layer for native execution of instructions in the translated memory bank by the programmable circuit.

21. The method of claim 10, further comprising determining whether an unlinked translated memory bank exists that corresponds to the second memory bank.

22. The method of claim 21, further comprising, upon determining that no linked or unlinked translated memory bank exists that corresponds to the second memory bank, translating and compiling a new translated memory bank based on contents of the second memory bank.

23. The method of claim 10, further comprising unlinking a translated memory bank from the emulator.

24. A computer-implemented method comprising:
initiating execution of an emulated operating system and one or more software programs within an emulator, the emulator operating within an interface layer and on a programmable circuit of a computing system having a first instruction set architecture, the emulated operating system and one or more software programs configured for execution using a second instruction set architecture incompatible with the first instruction set architecture;
retrieving an instruction to be executed as part of the one or more software programs, the instruction included in a current memory bank;
determining whether the instruction results in a transfer to a memory bank different from the current memory bank;
if the instruction results in transfer to a memory bank different from the current memory bank, determining whether a translated memory bank corresponding to the memory bank is linked to the interface layer;
upon determining that the translated memory bank corresponding to the memory bank is not linked to the interface layer, initiating a linker component to link the translated memory bank to the interface layer; and
upon determining that the translated memory bank is linked to the interface layer, executing one or more instructions within the translated memory bank natively on the computing system.
